(19) United States
(12) Patent Application Publication
(10) Pub. No.: US 2024/0095420 A1
(43) Pub. Date: Mar. 21, 2024

(54) NON-COMBUSTIBLE ACTIVE SUBSTANCE DELIVERY ARTICLE DESIGN SYSTEM AND METHOD

(71) Applicant: British American Tobacco (Investments) Limited, London (GB)

(72) Inventors: Jailson DIAS, London (GB); Marcelo Caetano Alexandre MARCELO, London (GB); Erick REIS, London (GB); Samuel KAISER, London (GB); Priscila BRASIL DE SOUZA CRUZ, London (GB)

(21) Appl. No.: 18/262,795

(22) PCT Filed: Jan. 27, 2022
(86) PCT No.: PCT/GB2022/050213

§ 371 Date: Jul. 25, 2023

(30) Foreign Application Priority Data
Jan. 27, 2021 (GB) 2101101.0

(51) Int. Cl. G06F 30/20; A24B 13/00; A24C 5/01; A24D 1/20

(52) U.S. Cl. CPC G06F 30/20; A24B 13/00; A24C 5/01; A24D 1/20; G06F 2111/06

(57) ABSTRACT

A method of designing a target non-combustible active substance delivery article includes receiving respective values for a plurality of input parameters, calculating respective values for a plurality of design parameters for the non-combustible active substance delivery article based on the received values for the plurality of input parameters, the plurality of design parameters including comprising at least two parameters selected from: a tobacco blend composition or an aerosol-generating material composition; tobacco or aerosol-generating material weight; nicotine and/or other active substance deliveries; aerosol constituent deliveries; a sensory attribute; a number of puffs associated with the non-combustible active substance delivery article; non-combustible active substance delivery article dimensions; rod of aerosol-generating material and/or tobacco density; filter density; rod of aerosol-generating material and/or tobacco firmness; filter firmness; open and/or closed article pressure drop; filter pressure drop; cigarette paper porosity; ventilation level; a heating profile; and flavor flavour composition, and providing the calculated values as an output.

### PRIORITY CLAIM

The present application is a National Phase entry of PCT Application No. PCT/GB2022/050213, filed Jan. 27, 2022, which claims priority from GB Application No. 2101101.0, filed Jan. 27, 2021, each of which is hereby fully incorporated herein by reference.

### TECHNICAL FIELD

The present disclosure relates to non-combustible active substance delivery articles, and in particular to systems and methods for designing and simulating non-combustible active substance delivery articles.

### BACKGROUND

Designing a non-combustible active substance delivery article involves the selection of various properties of the non-combustible active substance delivery article. For example, designing an article for use in a non-combustible active substance delivery system may include selecting a tobacco blend or an aerosol-generating material composition; article dimensions; filter type; filter properties; tobacco or aerosol-generating material weight; article density; article firmness; and cigarette paper porosity. The selection of these properties may affect the sensory attributes and the active substance delivery of the non-combustible active substance delivery article.

### SUMMARY

In accordance with a first aspect, this specification describes a method of designing a target non-combustible active substance delivery article. The method includes receiving respective values for a plurality of input parameters; calculating respective values for a plurality of design parameters for the article based on the received values for the plurality of input parameters; and providing the calculated values as an output. The plurality of design parameters includes at least two parameters selected from: a tobacco blend composition or an aerosol-generating material composition; aerosol-generating material or tobacco weight; nicotine and/or other active substance deliveries; aerosol constituent deliveries; a sensory attribute; a number of puffs associated with the non-combustible active substance delivery article; non-combustible active substance delivery article dimensions; rod of aerosol-generating material and/or tobacco density; filter density; rod of aerosol-generating material and/or tobacco firmness; filter firmness; open and/or closed article pressure drop; filter pressure drop; cigarette paper porosity; ventilation level; and flavor composition.

In accordance with a second aspect, the specification describes a computer program including instructions which, when the program is executed by a computer, cause the computer to carry out the method in accordance with the first aspect above.

In accordance with a third aspect, the specification describes a computer-readable storage medium comprising instructions which, when executed by a computer, cause the computer to carry out the method in accordance with the first aspect above.

In accordance with a fourth aspect, the specification describes a data processing apparatus comprising a processor and a computer-readable storage medium in accordance with the third aspect.

In accordance with a fifth aspect, the specification describes a system including a data processing apparatus in accordance with the fourth aspect and an article manufacturing apparatus. The system is configured to carry out the method in accordance with the first aspect above.

In accordance with a sixth aspect, the specification describes a system comprising a non-combustible active substance delivery article manufactured according to the calculated values for the design parameters output by the method of the first aspect above, and, a non-combustible aerosol provision device for heating at least a portion of the article.

### BRIEF DESCRIPTION OF THE DRAWINGS

Embodiments of the disclosure will now be described, by way of example only, with reference to the accompanying drawings, in which:

FIG. 1 is a schematic block diagram illustrating a system for designing a non-combustible active substance delivery article.

FIG. 2 is a schematic block diagram illustrating a system component for calculating design parameters for a non-combustible active substance delivery article.

FIG. 3 is a flow diagram of a method for designing a non-combustible active substance delivery article.

FIG. 4 is a flow diagram of a method for performing an optimization procedure directed to deriving a descriptor for a target non-combustible active substance delivery article.

FIG. 5 illustrates performing an example crossover operation to derive a new non-combustible active substance delivery article descriptor based on existing non-combustible active substance delivery article descriptors.

FIG. 6 is a schematic illustration of a filtered non-combustible active substance delivery article.

FIG. 7 illustrates a comparison of estimates of aerosol sensory attributes of a non-combustible active substance delivery article derived according to example embodiments with sensory attribute values obtained using other methods.

### DETAILED DESCRIPTION OF THE DRAWINGS

Example implementations provide system(s) and method(s) for designing and simulating non-combustible active substance delivery articles. The described systems and methods may facilitate designing and prototyping non-combustible active substance delivery articles in silico, reducing the time and cost of developing new non-combustible active substance delivery articles. Implementations may also facilitate the design of non-combustible active substance delivery articles having similar sensory attributes to an existing non-combustible active substance delivery article while using a different tobacco blend or aerosol-generating material composition; having different nicotine and/or other active substance deliveries; aerosol constituent deliveries; and/or being in a different format.

As used herein, the term “delivery system” is intended to encompass systems that deliver at least one substance to a user, and includes:
non-combustible aerosol provision systems that release compounds from an aerosol-generating material without combusting the aerosol-generating material, such as electronic cigarettes, tobacco heating products, and hybrid systems to generate aerosol using a combination of aerosol-generating materials; and
aerosol-free delivery systems that deliver the at least one substance to a user orally, nasally, transdermally or in another way without forming an aerosol, including but not limited to, lozenges, gums, patches, articles comprising inhalable powders, and oral products such as oral tobacco which includes snus or moist snuff, wherein the at least one substance may or may not comprise nicotine.

Such delivery systems may be referred to herein as non-combustible active substance delivery systems. A non-combustible active substance delivery system may comprise a non-combustible active substance delivery article. Such articles may be referred to herein as a consumable or an article. Said articles may be designed by the system, method, or apparatus described herein.

In some embodiments, the substance to be delivered comprises an active substance.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis, coffee, yerba mate, or another botanical.

In some embodiments, the active substance comprises nicotine. In some embodiments, the active substance comprises caffeine, melatonin, limonene, carvone, menthol, theobromine, or vitamin B12, among others.

Aerosol-generating material is a material that is capable of generating aerosol, for example when heated, irradiated or energized in any other way. Aerosol-generating material may, for example, be in the form of a solid, liquid or gel which may or may not contain an active substance and/or flavorants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavors, one or more aerosol-former materials, and optionally one or more other functional material.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, coloring agents, preservatives, binders, fillers, stabilizers, and/or antioxidants.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

In some embodiments, the disclosure relates to consumables comprising aerosol-generating material and configured to be used with non-combustible aerosol provision devices.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energized so as to distribute power in the form of heat to an aerosol-generating material or to a heat transfer material in proximity to the exothermic power source.

In some embodiments, the delivery system is an aerosol-free delivery system that delivers at least one substance to a user orally, nasally, transdermally or in another way without forming an aerosol, including but not limited to, lozenges, gums, patches, articles comprising inhalable powders, and oral products such as oral tobacco which includes snus or moist snuff, wherein the at least one substance may or may not comprise nicotine. In some cases, the aerosol-free delivery system may consist essentially of, or consist of an article according to embodiments described herein.

### Non-Combustible Active Substance Delivery Article Design System

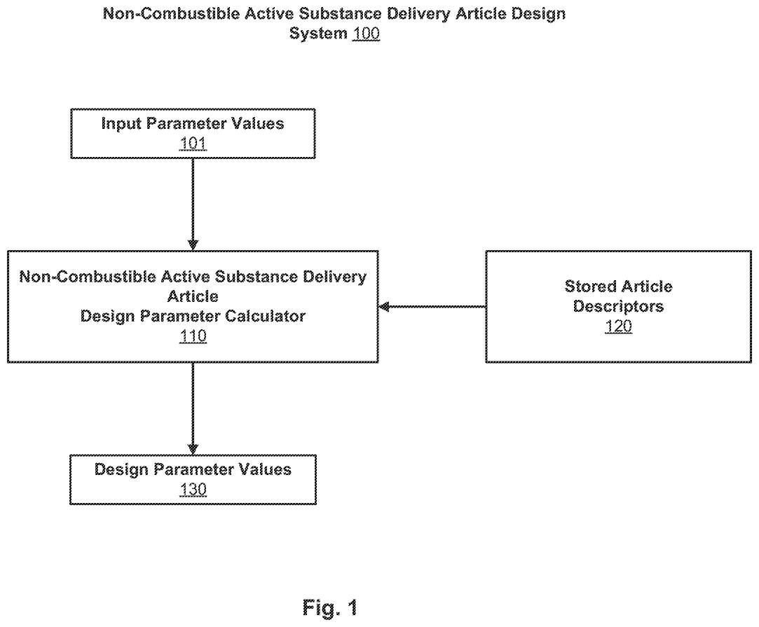

FIG. 1 is a schematic block diagram illustrating a system 100 for designing a non-combustible active substance delivery article.

The article design system 100 is implemented using one or more suitable computing devices. For example, the one or more computing devices may be any of or any combination of one or more desktop computers, one or more notebook computers, one or more tablet computers, one or more workstation computers, one or more mainframe computers, and one or more blade server computers. In embodiments where the article design system 100 is implemented using a plurality of computing devices, the computing devices may be configured to communicate with each other. The communication may be via one or more peripheral interfaces and/or over one or more networks. The one or more networks may be any of or any combination of the internet, local area networks, cellular networks and wireless networks. The non-combustible active substance delivery article design system may be implemented using a numerical computing environment and/or framework, e.g. MATLAB, Mathematica, NumPy and/or R. The article design system may also be implemented using one or more suitable programming languages. Examples of suitable programming languages are Python, C, C++, C# and Java.

The article design system 100 includes input parameter values 101, a non-combustible active substance delivery article design parameter calculator 110, stored article descriptors 120 and design parameter values 130.

The input parameter values 101 are desired and/or set values for parameters of a target article. The parameters may include, but are not limited to, one or more of aerosol-generating material composition or tobacco blend parameters; sensory attributes; nicotine and/or other active substance deliveries; aerosol constituent deliveries; flavor compositions; heating profiles; and parameters describing the physical properties and/or composition of an article.

Aerosol-generating material composition parameters include the type and proportions of one or more active substances and/or flavors, one or more aerosol-former materials, and optionally one or more other functional materials.

Examples of tobacco blend parameters include the proportions of each of a number of tobacco varieties and/or qualities. Examples of macro tobacco variety groups include flue-cured Virginia, air-cured Burley, specially processed, sun-cured Oriental, Cavendish style, stem, reconstituted tobacco, and tobacco or reconstituted tobacco formed from non-stem tobacco by-products.

Varieties of flue-cured Virginia tobacco include Lemon, Orange and Mahogany tobacco varieties. Varieties of air-cured Burley tobacco include Light Mahogany, Mahogany and Dark Mahogany. Varieties of specially processed tobacco include, Dark Fire-Cured and Galpao Comum. Varieties of sun-cured Oriental tobacco include Samsun, Basma, and Izmir. Reconstituted tobacco, for instance formed from tobacco by-products and/or stem, includes the tobacco material as described in PCT patent publication no. WO2006061117 and US patent publication no. U.S. Pat. No. 5,562,108, the contents of each of which are incorporated herein by reference. At least some of these tobacco varieties are available in several quality grades, e.g. high quality and medium quality.

The tobacco blend parameters may include indications that tobacco of one or more given variety groups, varieties and/or qualities should or should not be included in the target article. For example, the parameters may indicate that a tobacco blend of flue-cured Virginia tobacco, tobacco stem and reconstituted tobacco is desired.

Flavor composition parameters may include alkaloids, xanthines, flavonoids, terpenoids, and freshness, among other compounds.

Examples of aerosol sensory attributes for an article for a non-combustible aerosol provision system include draw effort, impact, irritation, taste intensity, tobacco aroma, visible aerosol, and aerosol volume. Examples of sensory attributes of aerosol-free non-combustible active substance delivery articles include overall intensity; specific flavor components such as mint, smoky, earthy and bitter; cooling; moisture; and mouth coating.

The sensory attributes of an aerosol or an aerosol-free article may be represented using numerical values which are indicative of the sensory impression of an article on consumers according to data and/or models derived using consumer surveys and/or focus groups.

Examples of parameters describing the physical properties and/or composition of the article include a number of puffs associated with the article, for instance the maximum number of puffs achievable from the product under a standard heating regime, article dimensions including at least one of the length of a rod of aerosol-generating material, filter plug length, tipping length and circumference of product, net aerosol-generating material or tobacco weight, filter plug pressure drop (for instance encapsulated pressure drop), total article pressure drop, for instance with any ventilation openings open and/or closed, ventilation rate, firmness, article density, and cutting process (for instance long cut or short cut tobacco). The firmness and/or density may, for instance, be the firmness or density of the rod of aerosol-generating material or of the filter. Firmness can, for instance, be measured using hardness measurement equipment supplied by Borgwaldt or others and based on product diameter measurements before and after the product has been subjected to a given load. The density can be calculated as the weight of a component of the product per unit of volume for that component.

The design parameter values 130 are calculated values for a number of design parameters of the target article. The design parameters may be any number of the parameters described above in relation to the input parameters 101. The design parameters may include one or more parameters of the article which were not input parameters.

The design parameters may be understood as parameters for which values are to be chosen such that the target article has the provided values for the input parameters, or as close as is achievable. For example, the input parameter values may indicate that the target article is desired to have certain sensory attribute values and have a blend consisting of given tobacco varieties; and the values for the design parameters may describe the physical properties and/or composition of the target article and the proportions of the tobacco varieties in the blend such that the target article has properties matching, or at least resembling, the received values for the input parameters.

The article design parameter calculator 110 receives the input parameter values 101, and calculates the design parameter values 130 for an article based on the received input parameter values 101.

In calculating the design parameter values 130, the article design parameter calculator 110 may derive a target article descriptor. Article descriptors may include values for the design parameters and values for the input parameters. The values of a given article descriptor for the design parameters and input parameters may be unscaled values for the parameters, i.e. each of the values may be of the same scale as the corresponding input parameter or design parameter value. Alternatively, the values of a given article descriptor for the design parameters and input parameters may have undergone feature scaling, e.g. each the values for the parameter may have been rescaled using an appropriate method such as min-max normalization, mean normalization or standardization. Different rescaling methods may be appropriate for different parameters and, as such, the values of a given article descriptor for different parameters may be rescaled according to different methods. In some instances, the values of a given article descriptor for some of the parameters may have undergone feature scaling while others may have not. Where the values of the target article descriptor have undergone feature scaling, the article design parameter calculator 110 may transform at least the values of the target article descriptor into an appropriate scale for the design parameter values, e.g. design parameter values understandable by a design system user and/or usable for manufacturing the target article.

Article descriptors may be implemented using any suitable data structure. Suitable data structures include, but are not limited to, arrays, vectors, matrices, rows and/or columns of matrices, in-memory objects, markup language files, serialized binary data, database entries and text data.

The target article design parameter calculator 110 may derive the target article descriptor by performing an optimization procedure, which may be a stochastic optimization procedure. For example, the optimization procedure may be any of particle swarm optimization, ant colony optimization, simulated annealing, a Monte Carlo algorithm, Runge-Kutte methods, a genetic algorithm, or any combination thereof. Where a genetic algorithm is used, it may be a real coded genetic algorithm. The optimization procedure may be directed towards deriving a target article having a maximal fitness. The fitness of a given article descriptor may be based on differences between the input parameter values 101, or a feature scaling thereof, and the corresponding values of the target article descriptor.

The fitness of a given article descriptor may be measured using a fitness function or loss function. Where a fitness function is used, a greater value of the fitness function for the given article descriptor indicates a greater fitness. Where a loss function is used, a lesser value of the loss function for the article descriptor indicates a greater fitness. For example, the fitness of an article descriptor may be inversely related to the root mean square deviation, also referred to as the root mean square error, between the input parameter values 101, or a feature scaling thereof, and the corresponding values of the target article descriptor, and, this root mean square deviation used as a loss function. This root mean square deviation may be denoted as:

$$\frac{1}{N} \sqrt{{\sum }_{i = 1}^{N} {( {p}_{i} - {c}_{i} )}^{2}} ,$$

where N is the number of input parameters, pᵢ is the ith input parameter value, or a feature scaling thereof, and cᵢ is the value of a given article descriptor for the ith input parameter.

The stored article descriptors 120 may be used by the article design parameter calculator 110 in the derivation of the design parameter values 130. For example, the stored article descriptors may be used to derive the target article descriptor. The stored article descriptors 120 may be implemented using any suitable data structure for article descriptors, including those previously referred to. The stored article descriptors 120 may be stored using any suitable data storage mechanism, e.g. file system storage, database storage or an in-memory cache. The stored article descriptors 120 may have been derived using measurements of physical qualities and properties; chemometric analysis; and/or results of consumer focus groups and/or panels. Some of the stored article descriptors 120 may have been derived using a chemosensory model such as that described in WO2018007789A1,the contents of which are incorporated herein by reference.

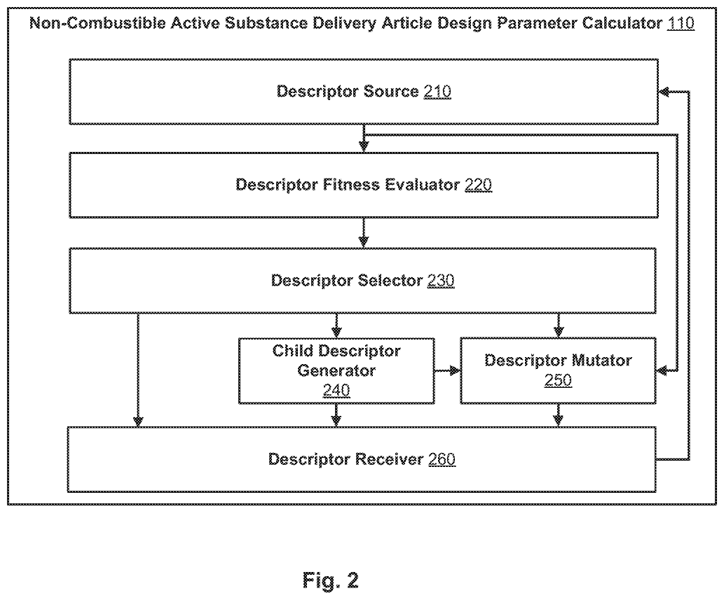

The target article descriptor may be derived by using a plurality of the stored article descriptors, or a feature scaling thereof, as initial article descriptors. The article design calculator 110 may evaluate the fitness of the initial article descriptors and derive new article descriptors based on a selected subset of them, e.g. the fittest/initial article descriptors may be used to derive the new article descriptors. The fitness of these new article descriptors may then be evaluated and a selected subset of the new article descriptors used to generate a further generation of article descriptors. Subsequent generations may then be generated, each of the subsequent generations derived from a selected subset of the article descriptors of the preceding generation. The target article descriptor may be the fittest article descriptor of the last generation. A related example embodiment of the article design parameter calculator 110 is described in relation to FIG. 2.

The non-combustible active substance delivery article design system 100 may also include an article manufacturing apparatus (not shown). The design parameter values may be provided to the article manufacturing apparatus and used to manufacture the target article.

### Non-Combustible Active Substance Delivery Article Design Parameter Calculator

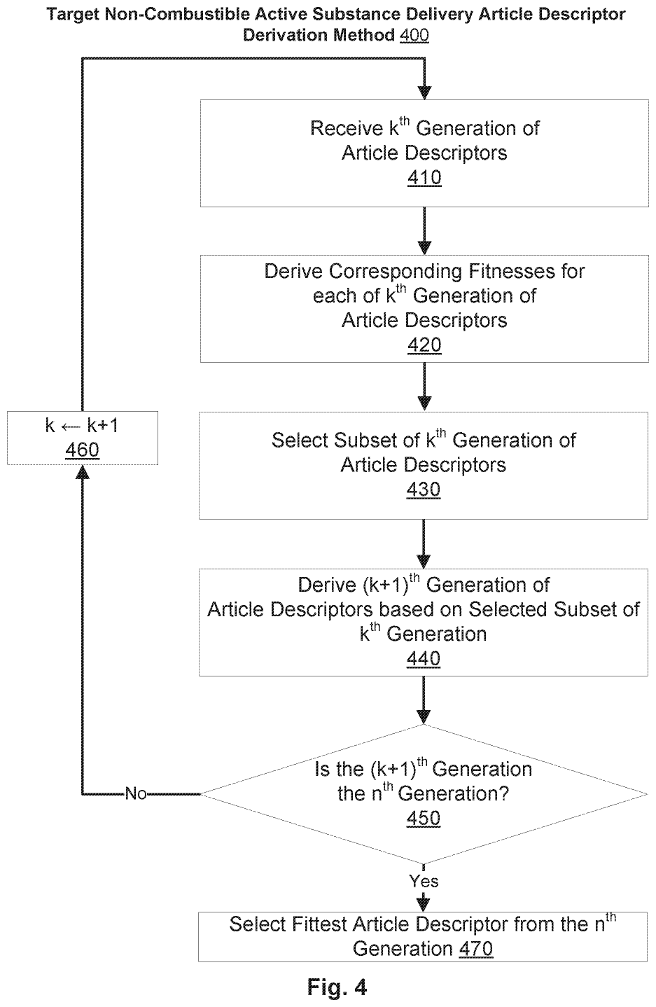

FIG. 2 is a schematic block diagram illustrating an example embodiment of the component 110 of the article design system 100 for calculating design parameters for an article. The illustrated example embodiment may perform the article optimization method 400 described in relation to FIG. 4.

The illustrated embodiment of the article design parameter calculator 110 includes a descriptor source 210, a descriptor fitness evaluator 220, a descriptor selector 230, a child descriptor generator 240, a descriptor mutator 250 and a descriptor receiver 260. The illustrated article design parameter calculator uses these included components to perform one or more processing iterations in which article descriptors are generated.

The descriptor source 210 is a source of article descriptors. The descriptor source may be a source of stored article descriptors 120. These stored article descriptors 120 may be retrieved by the descriptor source 210 from a suitable data storage system, such as a database or file storage system, or from an in-memory cache. Where article descriptors have already been generated, e.g. in a preceding iteration, the descriptor source may also be a source of these generated article descriptors. These generated article descriptors may have been retrieved or received from the descriptor receiver 260.

The descriptor fitness evaluator 220 receives article descriptors from the descriptor source 210. The received article descriptors may be a set of stored article descriptors in the first iteration and, in subsequent iterations, may be the article descriptors derived and/or otherwise received by the descriptor receiver 260 during the preceding iteration. The descriptor fitness evaluator evaluates the fitness of each of the received article descriptors using a fitness function or loss function based on the input parameter values, as previously described.

The descriptor selector 230 receives the article descriptors and associated fitness values from the descriptor fitness evaluator.

If the descriptor selector 230 determines that the final iteration has been reached then the descriptor selector may select the fittest article descriptor of the received article descriptors based on the associated fitness values and provide it to the descriptor receiver 260 with an indication that the final iteration has been reached. The descriptor selector 230 may determine that the final iteration has been reached if an iteration limit has been reached, e.g. the current iteration is the 100^{th} iteration and only a maximum of 100 iterations are to be performed. Alternatively, the descriptor selector 230 may determine that the final iteration has been reached if the fittest article descriptor has a fitness greater than a threshold fitness, e.g. if the loss function is below a given value.

If the descriptor selector 230 does not determine that the final iteration has been reached, the descriptor selector may proceed with one or more of the following operations.

The descriptor selector 230 may select one or more elite descriptors and provide them to the descriptor receiver 260. The one or more elite descriptors may be the K article descriptors of the received article descriptors having the greatest fitnesses.

The descriptor selector may also select a plurality of parent article descriptors and provide them to the child descriptor generator 240. The plurality of parent descriptors may be the N article descriptors of the received article descriptors having the greatest fitnesses, where N may be greater than K. Alternatively, a probabilistic procedure may be used, such as fitness proportionate selection, where the parent descriptors are selected by selecting descriptors from the received article descriptors with a probability based on their fitness, i.e. article descriptors with a greater fitness are more likely to be selected.

The descriptor selector 230 may also select one or more article descriptors for mutation and provide them to the descriptor mutator 250. The one or more descriptors for mutation may be selected at random from the received article descriptors or from a subset of the received article descriptors, e.g. the fittest M of the received article descriptors, or the parent article descriptors. The one or more descriptors for mutation may also be selected by selecting descriptors from the received article descriptors with a probability based on their fitness.

The child descriptor generator 240 receives the plurality of parent article descriptors from the descriptor selector and uses them to generate child article descriptors. Each child article descriptor may be generated by performing a crossover operation of two or more of the parents. The parents to be crossed over to generate each child may be chosen (pseudo)randomly or according to fixed combinations, e.g. the first parent with the second parent, the third parent with the fourth parent etc. The crossover operation may linearly combine two or more parent descriptors, with each of the parents weighted in the combination using a (pseudo)random variable. For example, where two parent descriptors, x and y, are used to generate a child descriptor, c, the child descriptor may be:

c=αx+(1−α)y

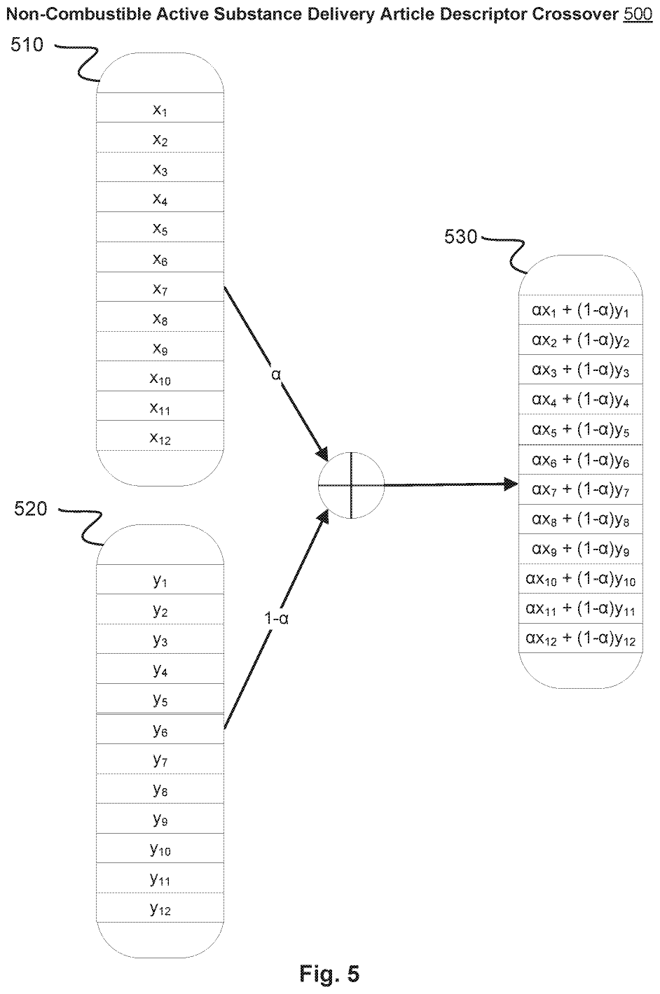

, where α is a (pseudo)random variable between 0 and 1, as illustrated in FIG. 5.

The descriptor mutator 250 may receive the one or more article descriptors for mutation from the descriptor selector and uses them to generate mutated article descriptors. Alternatively or additionally, the descriptor mutator may receive one or more child article descriptors for mutation from the child descriptor generator. Each mutated article descriptor may be generated by performing a crossover operation of a descriptor for mutation with a stored article descriptor received via the descriptor source 210. The crossover operation may linearly combine a descriptor for mutation with a stored article descriptor, with each weighted in the combination using a (pseudo)random variable. For example, where a descriptor for mutation, d, and a stored descriptor, s, are used to generate a mutated descriptor, m, the mutated descriptor may be:

m=(1−β)d+βs,

where β is a pseudo(random) variable between 0 and 1. β may be constrained to be or be more likely to be towards the lower end of this stated range, e.g. between 0 and 0.1.

If the descriptor receiver 260 receives an indication that the final iteration has been reached, the descriptor receiver 260 also receives the fittest article descriptor of the final iteration, which is the target article descriptor. The descriptor receiver 260 uses the target article descriptor to obtain the design parameter values, as previously described, and provides them as an output.

Otherwise, the descriptor receiver 260 receives the one or more elite article descriptors; the child article descriptors; and the one or more mutated article descriptors. The descriptor receiver may provide the article descriptors which it has received to the descriptor source 210.

### Non-Combustible Active Substance Delivery Article Design Method

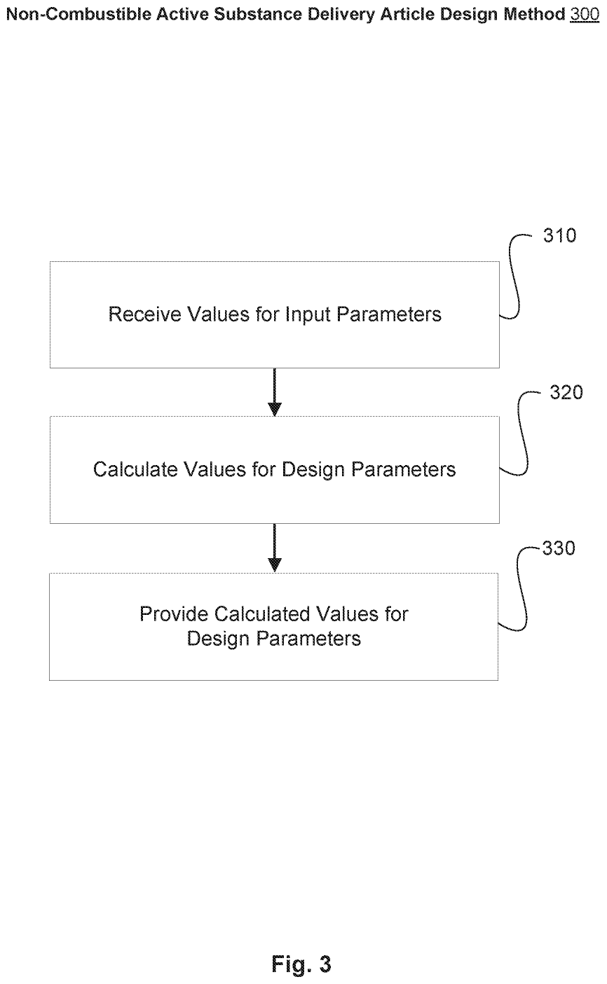

FIG. 3 is a flow diagram illustrating an example method for designing a target article. The method may be performed by executing computer-readable instructions using one or more processors of one or more computing devices, e.g. the one or more computing devices implementing the article design system 100.

In 310, values for a plurality of input parameters are received. The values for the plurality of input parameters are desired and/or set values for parameters of the target article. The parameters may include, but are not limited to, one or more of tobacco blend or aerosol-generating material parameters; sensory attributes; nicotine and/or other active substance deliveries; aerosol constituent deliveries; and parameters describing the physical properties and/or composition of an article. Examples of such parameters are described in detail in relation to the input parameter values 101 of article design system 100.

In 320, values for a plurality of design parameters for the target article are calculated based on the received values for the plurality of input parameters. The design parameters may be any number of the parameters described above as being usable as input parameters. The design parameters may include one or more parameters of the article which were not input parameters.

The plurality of values for the design parameters may be calculated such that the target article has the received values for the plurality of input parameters, or as close as is achievable. For example, the values for the plurality of input parameters may indicate that the target article is desired to have certain sensory attribute values and have a blend consisting of given tobacco varieties; and the values for the design parameters may describe the physical properties and/or composition of the target article and the proportions of the tobacco varieties in the blend such that the target article has properties matching, or at least resembling, the received values for the input parameters.

The calculation of the values for the plurality of design parameters may include deriving a target article descriptor. Article descriptors may include values for the plurality of design parameters and values for the plurality of input parameters. The value of a given article descriptor may be unscaled or may have undergone feature scaling, as described in relation to the deriving of article descriptors in the example article design system 100. Where the values of the target article descriptor have undergone feature scaling, the calculation of the values for the plurality of design parameters may include transforming at least the values of the target article descriptor for the plurality of design parameters into a scale appropriate for being provided as an output. For example, the values may be transformed into a scale understandable by a designer of articles and/or usable for manufacturing the target article.

Article descriptors may be implemented using any suitable data structure. Suitable data structures include, but are not limited to, arrays, vectors, matrices, rows and/or columns of matrices, in-memory objects, markup language files, serialized binary data, database entries and text data.

The target article descriptor may be derived by performing an optimization procedure, which may be a stochastic optimization procedure. For example, the optimization procedure may be any of particle swarm optimization, ant colony optimization, simulated annealing, a Monte Carlo algorithm, Runge-Kutte methods, a genetic algorithm, or any combination thereof. Where a genetic algorithm is used, it may be a real coded genetic algorithm. The optimization procedure may be directed towards deriving a target article having a maximal fitness. The fitness of a given article descriptor may be based on differences between the values for the plurality of input parameters, or a feature scaling thereof, and the corresponding values of the target article descriptor.

The fitness of a given article descriptor may be measured using a fitness function or loss function. Where a fitness function is used, a greater value of the fitness function for the given article descriptor indicates a greater fitness. Where a loss function is used, a lesser value of the loss function for the article descriptor indicates a greater fitness. For example, the fitness of an article descriptor may be inversely related to the root mean square deviation, also referred to as the root mean square error, between the values for the plurality of input parameters, or a feature scaling thereof, and the corresponding values of the target article descriptor, and, this root mean square deviation used as a loss function. This root mean square deviation may be denoted as:

$$\frac{1}{N} \sqrt{{\sum }_{i = 1}^{N} {( {p}_{i} - {c}_{i} )}^{2}} ,$$

where N is the number of input parameters, pᵢ is the value for the ith of the plurality of input parameters, or a feature scaling thereof, and cᵢ is the value of a given article descriptor for the ith of the plurality of input parameters.

The calculation of the values for the plurality of design parameters may be based on a plurality of stored article descriptors. For example, the target article descriptor may be derived using the plurality of stored article descriptors. The stored article descriptors may be implemented using any suitable data structure for article descriptors, include those previously referred to. The plurality of stored article descriptors may be retrieved from any suitable data storage mechanism storing the plurality, or a greater plurality, of article descriptors, e.g. the stored article descriptors may be retrieved from file system storage, database storage or an in-memory cache.

The target article descriptor may be derived by using a plurality of the stored article descriptors, or a feature scaling thereof, as initial article descriptors. The fitness of the initial article descriptors may be evaluated and new article descriptors may be derived based on a selected subset of them, e.g. the fittest/initial article descriptors may be used to derive the new article descriptors. The fitness of these new article descriptors may then be evaluated and a selected subset of the new article descriptors used to generate a further generation of article descriptors. Subsequent generations may then be generated, each of the subsequent generations derived from a selected subset of the article descriptors of the preceding generation. The target article descriptor may be the fittest article descriptor of the last generation. A related example method for deriving the target article descriptor is described in relation to FIG. 4.

In operation 330, the values for the design parameters are provided as an output. The values for the design parameters may be displayed to an article designer using a suitable graphical interface and/or may be used by an article manufacturing apparatus to manufacture the target article.

### Non-Combustible Active Substance Delivery Article Descriptor Optimization Method

FIG. 4 is a flow diagram illustrating an example method 400 for deriving a target article descriptor. The method may be performed by executing computer-readable instructions using one or more processors of one or more computing devices, e.g. the one or more computing devices implementing the article design system 100.

The described operations are repeated for a number of iterations. A total of (n−1) iterations are performed to derive an nth generation of article descriptors. The number n is an integer greater than or equal to two. The number n may be a fixed number or may denote the generation in which an end criterion is met. For example, n may denote the generation in which the fittest article descriptor has a fitness greater than a threshold fitness, e.g. the loss function value for that descriptor is below a given value.

In operation 410, the kth generation of article descriptors is received. If the kth generation is the first generation of article descriptors, the received article descriptors may be received from a suitable data storage system, such as a database or file storage system, or from an in-memory cache. Otherwise, the received article descriptors may be those derived in the preceding generation.

In operation 420, corresponding fitnesses for each of the kth generation of article descriptors are derived. The fitness of each of the kth generation of article descriptors may be derived using a fitness function or loss function based on the values of the respective article descriptor for the input parameters, as previously described.

In operation 430, one or more subsets of the kth generation of article descriptors are selected.

An elite subset of article descriptors may be selected. The elite subset of article descriptors may be the M article descriptors of the kth generation of article descriptors having the greatest fitnesses.

A parent subset of article descriptors may be selected. The parent subset may be the M article descriptors of the article descriptors kth generation of article descriptors having the greatest fitnesses, where M may be greater than K. Alternatively, a probabilistic procedure may be used to select the parent subset, such as fitness proportionate selection, where the parent descriptors are selected by selecting descriptors from the kth generation of article descriptors with a probability based on their fitness, i.e. article descriptors with a greater fitness are more likely to be selected.

A mutatee subset of article descriptors may be selected. The mutatee subset may be selected at random from the kth generation of article descriptors or from a subset of the kth generation of article descriptors, e.g. the fittest M of the kth generation of article descriptors, or the parent subset of kth generation of article descriptors. The mutatee subset may also be selected by selecting descriptors from kth generation of article descriptors with a probability based on their fitness.

In operation 440, a (k+1)th generation of article descriptors is derived based on the one or more selected subsets of the kth generation of article descriptors.

The (k+1)th generation of article descriptors may include the elite subset of the kth generation of article descriptors.

The (k+1)th generation of article descriptors may include child descriptors derived based on the parent subset of the kth generation of article descriptors. Each child article descriptor may be generated by performing a crossover operation of two or more of the parent subset. The parents to be crossed over to generate each child may be chosen (pseudo)randomly or according to fixed combinations, e.g. the first parent with the second parent, the third parent with the fourth parent etc. The crossover operation may linearly combine two or more of the descriptors in the parent subset, with each of the parents weighted in the combination using a (pseudo)random variable. For example, where two parent descriptors, x and y, are used to generate a child descriptor, c, the child descriptor may be:

c=αx+(1−α)y

, where α is a (pseudo)random variable between 0 and 1, as illustrated in FIG. 5.

The (k+1)th generation of article descriptors may include mutated article descriptors derived based on the mutatee subset of the kth generation of article descriptors. The (k+1)th generation of article descriptors may also include mutated article descriptors derived based on a mutatee subset of the child article descriptors. Each mutated article descriptor may be generated by performing a crossover operation of a descriptor from a mutatee subset with a stored article descriptor. The crossover operation may linearly combine an article descriptor from a mutatee subset with a stored article descriptor, with each weighted in the combination using a (pseudo)random variable. For example, where a mutatee descriptor, d, and a stored descriptor, s, are used to generate a mutated descriptor, m, the mutated descriptor may be:

m=(1−β)d+βs

, where β is a pseudo(random) variable between 0 and 1. β may be constrained to be or be more likely to be towards the lower end of this stated range, e.g. between 0 and 0.1.

In operation 450, it is determined whether the (k+1)th generation of descriptors is the nth generation of descriptors. Where there are a fixed number of iterations are performed, the determination may comprise determining whether (k+1) is equal to n. In embodiments where n denotes that an end criterion is met, determining whether the (k+1)th generation is the nth generation includes the determining whether the (k+1)th generation of descriptors satisfies the end criterion. For example, it may be determined whether the fittest article descriptor of the (k+1)th generation has a fitness greater than a threshold fitness, e.g. the loss function value for that descriptor is below a given value. In response to it being determined that the (k+1)th generation of descriptors is the nth generation of descriptors, the method continues to operation 470. Otherwise, the method continues to operation 460.

Operation 460 indicates that the operations described above are to be repeated for the next generation. The value k may be understood to have been incremented to (k+1). In some embodiments, a variable storing the value of or a value relating to k may be increment, e.g. embodiments using a for loop and a fixed number of iterations. However, in other embodiments, no such variable may be used or maintained and instead the illustrated incrementing of k merely denotes that execution continues for the next generation.

In operation 470, the article descriptor of the nth generation of article descriptors having the greatest fitness is selected as the target article descriptor. As described in 320 of method 300, the target article descriptor is usable to derive values for the plurality of design parameters.

### Non-Combustible Active Substance Delivery Article Descriptor Crossover Example

FIG. 5 illustrates performing an example crossover operation 500 to derive a new non-combustible active substance delivery article descriptor based on existing article descriptors. The described crossover operation may be performed by the child descriptor generator 240 and/or the descriptor mutator of the non-combustible active substance delivery article design parameter calculator 110 described in relation to FIG. 2. The described crossover operation may also be performed in child generation and/or mutation operations performed in the descriptor generation derivation operation 440 of the target article descriptor derivation method 400.

The illustration 500 includes a first article descriptor 510, a second article descriptor 520 and a derived article descriptor 530.

The first article descriptor 510 is an article descriptor implemented as described above in relation to the system 100 and/or the method 300. The first article descriptor 510 may be a stored article descriptor; an article descriptor derived in a preceding iteration of article descriptor derivations; or an article descriptor derived during the present iteration, e.g. a child article descriptor which is to undergo mutation. The first article descriptor 510 may be represented as a vector, x, having elements xᵢ. Each of the elements may be a value for a respective input or design parameter. In the illustrated example, the first article descriptor 510 has 12 elements, x₁-x₁₂.

The second article descriptor 520 is also an article descriptor implemented as described above in relation to the system 100 and/or the method 300. The second article descriptor 520 may be a stored article descriptor; an article descriptor derived in a preceding iteration of article descriptor derivations; or an article descriptor derived during the present iteration, e.g. a child article descriptor which is to undergo mutation. The second article descriptor 520 may be represented as a vector, y, having elements yᵢ. Each of the elements may be a value for a respective input or design parameter. Each of the elements, yᵢ, may be a value for the same respective input or design parameter as the corresponding element of the first article descriptor, xᵢ. In the illustrated example, the second article descriptor 520 has 12 elements, y₁-y₁₂, which are values for the same 12 parameters as those in the first article descriptor, x₁-x₁₂,

The derived article descriptor 530 is derived by linearly combining, e.g. calculating a weighted sum of, the first article descriptor 510 and the second article descriptor 520. In the illustrated example, the derived article descriptor 530 is derived using a (pseudo)randomly generated number, α, which is in the range 0 to 1, and the derived article descriptor is the sum of the first article descriptor 510 multiplied by α and the second article descriptor 520 multiplied by (1−α), i.e.:

z=αx+(1−α)y,

where z is a vector representing the derived article descriptor 530. Therefore, as illustrated, the elements, zᵢ, of z are:

zᵢ=αxᵢ+(1−α)yᵢ

### Non-Combustible Active Substance Delivery Article

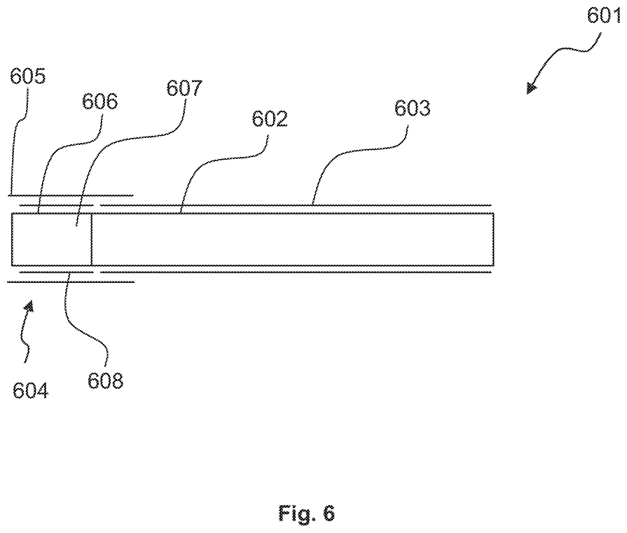

FIG. 6 is a schematic illustration of a non-combustible active substance delivery article 601.

While the illustrated non-combustible active substance delivery article 601 is a filtered aerosol-generating article, the systems and methods described in the present specification are also applicable to unfiltered articles, and aerosol-free articles.

Filtered articles such as cigarettes and their formats are often named according to the cigarette length: “regular” (typically in the range 68-75 mm, e.g. from about 68 mm to about 72 mm), “short” or “mini” (68 mm or less), “king-size” (typically in the range 75-91mm, e.g. from about 79 mm to about 88 mm), “long” or “super-king” (typically in the range 91-105 mm, e.g. from about 94 mm to about 101 mm) and “ultra-long” (typically in the range from about 110 mm to about 121 mm).

They are also named according to the cigarette circumference: “regular” (about 23-25 mm), “wide” (greater than 25 mm), “slim” (about 22-23 mm), “demi-slim” (about 19-22 mm), “super-slim” (about 16-19 mm), and “micro-slim” (less than about 16 mm). Accordingly, a cigarette in a king-size, super-slim format will, for example, have a length of about 83 mm and a circumference of about 17 mm.

Each format may be produced with filters of different lengths, smaller filters being generally used in formats of smaller lengths and circumferences. Typically the filter length will be from 15 mm, associated with short, regular formats, to 30 mm, associated with ultra-long super-slim formats. The tipping paper will have a greater length than the filter, for example from 3 to 10 mm longer.

The systems and methods described in the present specification are applicable to filtered articles in any of the above formats. The dimensions of a given filtered article, whether actual, simulated or designed, in any of the above formats may be values of an article descriptor for input parameters and/or design parameters.

The illustrated article 601 is generally cylindrical in shape and is in the demi-slim format, namely having an outer circumference of about 21 mm. The illustrated article 601 may be an actual, simulated or designed article and represented using a corresponding article descriptor including values for a plurality of input parameters and design parameters. The length and circumference of the illustrated non-combustible active substance delivery article 601, or a feature scaling thereof, may be values included in the corresponding article descriptor. Values indicative of other properties of the cigarette, such as its firmness, density and the pressure drop through the cigarette may also be included in the corresponding article descriptor, as previously described.

The illustrated article 601 includes a rod of aerosol-generating material 602. The rod of aerosol-generating material 602 may include tobacco of a given tobacco blend composition. Values indicative of the given tobacco blend composition may be included in the corresponding article descriptor. Values indicative of the weight and density of the rod of aerosol-generating material 602 may also be included in the corresponding article descriptor.

The rod of aerosol-generating material is wrapped in a wrapping material 603, in this example cigarette paper, connected longitudinally to a filter 604 by tipping material 605 overlaying the filter 604 and partially overlaying the wrapping material 603 so as to connect the filter 604 to the rod of aerosol-generating material 602. A value indicative of the lengths of the tipping material may be included in the corresponding article descriptor. A value indicative of the porosity of the wrapping material may also be included in the corresponding article descriptor. A value indicative of the burning additive (citrate) loading of the wrapping material may also be included in the corresponding article descriptor.

The filter 604 includes a filter plug 606 formed using continuous cellulose acetate fibers and a plasticizer wrapped in a plug wrap 608. A value indicative of the length of the filter plug may be included in the corresponding article descriptor. The filter plug includes absorbent material 607. The properties of the filter plug 604, including the properties of the absorbent material 607, may affect the pressure drop across the filter plug. A value indicative of the pressure drop across the filter plug may be included in the corresponding article descriptor. Values indicative of the properties of the absorbent material 607 may also be included in the corresponding article descriptor.

The article 601 is, in the present example, provided with ventilation holes (not shown) through the tipping material 605 and plug wrap 608, providing ventilation into the filter plug 606. The ventilation holes may be described using a ventilation rate. A value indicative of the ventilation rate may be included in the corresponding article descriptor.

In use, the article may be inserted in a device configured to heat the rod of aerosol-generating material.

The sensory attributes of the article may be assessed in use by consumers of the article. Values indicative of the consumers' impressions of these sensory attributes may be included in the corresponding article descriptor.

### Simulation Results Evaluations

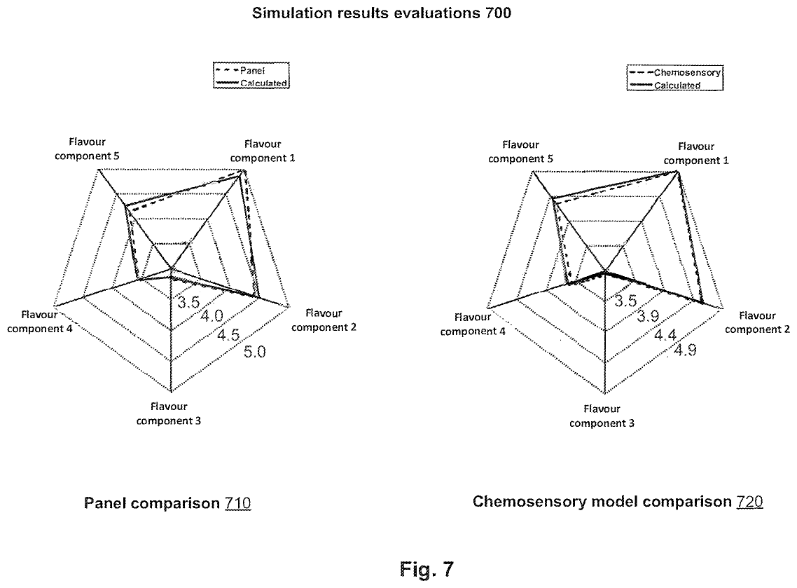

FIG. 7 is an illustration 700 of comparisons of estimates of aerosol sensory attributes of a non-combustible active substance delivery article derived according to example embodiments with sensory attribute values obtained using other methods. Aerosol sensory attributes may be estimated by example embodiments of the described systems and methods by using known properties of a non-combustible active substance delivery article as input parameters, e.g. aerosol-generating or tobacco material composition parameters and physical properties of the article, and the aerosol sensory attributes as the design parameters.

The illustration 700 includes a panel comparison graph 710.

The panel comparison graph 710 compares results for aerosol sensory attributes estimated by an embodiment of the method described herein with the results provided by a panel of consumers evaluating the aerosol sensory attributes. As the graph 710 illustrates, the results estimated by the embodiment are close to those given by the panel of consumers. Therefore, the described systems and methods may reduce the number of consumer evaluations, e.g. using surveys or focus groups, undertaken to evaluate articles during the design process.

The chemosensory model comparison graph 720 compares results for aerosol sensory attributes estimated by an embodiment of the method described herein with the results provided using a chemosensory model. As the graph 720 illustrates, the results estimated by the embodiment are close to those given by the chemosensory model. The chemosensory model uses chemical fingerprints to estimate the smoke sensory attributes. Chemical fingerprints are information dense and require a significant amount of processing. The chemosensory model uses more computational resources than the described systems and methods. Therefore, the described systems and method may reduce the computational resources used, e.g. using surveys or focus groups, to derive accurate estimates for the aerosol sensory attributes of an article.

In order to address various issues and advance the art, the entirety of this disclosure shows by way of illustration various embodiments in which that which is claimed may be practiced and provide for superior design and simulation of articles. The advantages and features of the disclosure are of a representative sample of embodiments only, and are not exhaustive and/or exclusive. They are presented only to assist in understanding and teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilized and modifications may be made without departing from the scope of the disclosure. Various embodiments may suitably comprise, consist of, or consist essentially of, various combinations of the disclosed elements, components, features, parts, steps, means, etc. In addition, the disclosure includes other inventions not presently claimed, but which may be claimed in future.

1. A method of designing a target non-combustible active substance delivery article, the method comprising:
receiving respective values for a plurality of input parameters;
calculating respective values for a plurality of design parameters for the target non-combustible active substance delivery article based on the received values for the plurality of input parameters, the plurality of design parameters comprising at least two parameters selected from:
a tobacco blend composition or an aerosol-generating material composition;
tobacco or aerosol-generating material weight;
nicotine or other active substance deliveries;
aerosol constituent deliveries;
a sensory attribute;
a number of puffs associated with the target non-combustible active substance delivery article;
non-combustible active substance delivery article dimensions;
rod of aerosol-generating material or tobacco density;
filter density;
rod of aerosol-generating material or tobacco firmness;
filter firmness;
open or closed article pressure drop;
filter pressure drop;
cigarette paper porosity;
ventilation level;
a heating profile; and
flavor composition and
providing the calculated values as an output.

2. The method of claim 1, wherein calculating the values for the design parameters comprises deriving a target non-combustible active substance delivery article descriptor, wherein the target non-combustible active substance delivery article descriptor comprises values for the design parameters and values for the input parameters for the target non-combustible active substance delivery article.

3. The method of claim 2, wherein deriving the target non-combustible active substance delivery article descriptor comprises performing an optimization procedure directed to deriving the target non-combustible active substance delivery article descriptor having a maximal fitness.

4. The method of claim 3, wherein the fitness of a given target non-combustible active substance delivery article descriptor is based on differences between the values of the given target non-combustible active substance delivery article descriptor for the input parameters and corresponding values based on the received values for the input parameters.

5. The method of claim 4, wherein the fitness of a given target non-combustible active substance delivery article is inversely related to a root mean square deviation between the values of the given target non-combustible active substance delivery article descriptor for the input parameters and corresponding values based on the received values for the input parameters.

6. The method of claim 3, wherein the performing of the optimization procedure comprises, repeating for each k between 1 and (n−1), where n≥2:
receiving a kth generation of non-combustible active substance delivery article descriptors;
deriving corresponding fitnesses for each of the kth generation of the non-combustible active substance delivery article descriptors;
selecting one or more subsets of the kth generation of the non-combustible active substance delivery article descriptors based on the corresponding fitnesses; and
deriving a (k+1)th generation of the non-combustible active substance delivery article descriptors based on the one or more subsets of the kth generation of non-combustible active substance delivery article descriptors,
wherein the target non-combustible active substance delivery article descriptor is the target non-combustible active substance delivery article descriptor of the nth generation having a greatest fitness.

7. The method of claim 6, wherein deriving the (k+1)th generation of the non-combustible active substance delivery article descriptors comprises deriving one or more child non-combustible active substance delivery article descriptors, wherein each of the one or more child non-combustible active substance delivery article descriptors is based on a respective two or more of the subset of the kth generation of the non-combustible active substance delivery article descriptors.

8. The method of claim 7, wherein each of the one or more child non-combustible active substance delivery article descriptors is a linear combination of the respective two or more of the subset of the kth generation of the non-combustible active substance delivery article descriptors.

9. The method of claim 7, wherein deriving the (k+1)th generation of the non-combustible active substance delivery article descriptors comprises mutating at least one of the one or more child non-combustible active substance delivery article descriptors.

10. The method of claim 3, wherein the optimization procedure is a stochastic optimization procedure.

11. The method of claim 10, wherein the stochastic optimization procedure is a genetic algorithm.

12. The method of claim 11, wherein the genetic algorithm is a real coded genetic algorithm.

13. The method of claim 10, wherein the optimization procedure comprises at least one selected from particle swarm optimization, ant colony optimization, simulated annealing, a Monte Carlo algorithm, Runge-Kutte methods, a genetic algorithm, or any combination thereof.

14. The method of claim 1, wherein the values for the plurality of design parameters are calculated based on a plurality of stored non-combustible active substance delivery article descriptors, wherein each of the stored non-combustible active substance delivery article descriptors comprises values for the plurality of design parameters and values for the plurality of input parameters for a corresponding non-combustible active substance delivery article.

15. The method of claim 14, further comprising deriving one or more of the plurality of stored non-combustible active substance delivery article descriptors using chemometric analysis.

16. The method of claim 1, wherein the plurality of input parameters comprise at least two parameters selected from:
a tobacco blend or an aerosol-generating material composition;
tobacco or aerosol-generating material weight;
nicotine or other active substance deliveries;
aerosol constituent deliveries;
a sensory attribute;
a number of puffs associated with the target non-combustible active substance delivery article;
non-combustible active substance delivery article dimensions;
rod of aerosol-generating material or tobacco density;
filter density;
rod of aerosol-generating material or tobacco firmness;
filter firmness;
open or closed article pressure drop;
filter pressure drop;
cigarette paper porosity;
ventilation level;
a heating profile; and
flavor composition.

17. The method of claim 1, wherein the target non-combustible active substance delivery article is a consumable article for a tobacco heating product device.

18. The method of claim 1, wherein the target non-combustible active substance delivery article is an oral tobacco product.

19. The method of claim 1, further comprising manufacturing the target non-combustible active substance delivery article based on the calculated values for the design parameter.

20. (canceled)

21. A non-transitory computer-readable storage medium comprising instructions which, when executed by a computer, cause the computer to carry out the method of claim 1.

22. A data processing apparatus comprising a processor and the non-transitory computer-readable storage medium as claimed in claim 21.

23. A system comprising:
a data processing apparatus comprising a processor and a non-transitory computer-readable storage medium comprising instructions; and
a non-combustible active substance delivery article manufacturing apparatus configured to carry out the method of claim 19.

24. A system comprising:
the target non-combustible active substance delivery article manufactured according to the calculated values for the design parameters output by the method of claim 1; and
a non-combustible aerosol provision device for heating at least a portion of the target non-combustible active substance delivery article.

25. A system according to claim 24, wherein the target non-combustible aerosol provision device is a tobacco heating system.
